(19) United States
(12) Patent Application Publication
(10) Pub. No.: US 2018/0074797 A1
(43) Pub. Date: Mar. 15, 2018

(54) TRANSFORM A DATA OBJECT IN A META MODEL BASED ON A GENERIC TYPE

(71) Applicant: HEWLETT PACKARD ENTERPRISE DEVELOPMENT LP, Houston, TX (US)

(72) Inventors: Andreas Ludwig, Boeblingen (DE); Matthias Franz, Altdorf (DE); Adrian Krug, Duesseldorf (DE)

(21) Appl. No.: 15/260,551

(22) Filed: Sep. 9, 2016

(51) Int. Cl. G06F 9/44

(52) U.S. Cl. CPC G06F 8/35

(57) ABSTRACT

The present disclosure relates to a method, system, and medium to transform a data object in a meta model based on a generic type. The system receives a request comprising a data object unrestricted to a predefined format from a client via a REST API. The system categorizes the data object into one of multiple generic types specified in a meta model. The plurality of generic types includes a thing, an information, a relationship, and a handler. Based on the categorized generic types, the system transforms the data object using a handler flow. A handler in the handler flow is defined by the client via the REST API based on receipt of the first request.

### BACKGROUND

Monitoring is one of the core capabilities for an Internet of Things (IoT) system. Generally, clients are mandated to send data in a specific format known to the IoT system. In recent years, support automation requirements changed from handling of hardware devices (e.g., servers, storage area networks (SANs), switches, routers, etc.) to supporting new types of software applications and appliances. In the future, a variety of new technologies (e.g. the IoT) will increase the need for flexible handling of support data tailored to individual types and for supporting complex solutions with an infrastructure that provides the flexibility and scalability.

### BRIEF DESCRIPTION OF THE DRAWINGS

The following detailed description references the drawings, wherein:

FIG. 1 is a block diagram of an example environment for an IoT meta model;

FIG. 2 is a block diagram of an example model definition processing component in the IoT meta model;

FIG. 3 is a block diagram of an example administrative object processing component in the IoT meta model;

FIG. 4 is a block diagram of an example typed object processing component in the IoT meta model;

FIG. 5 is a flowchart of an example process to transform a data object in a meta model based on a generic type;

FIG. 6 is a flowchart of an example process to transform a data object in a meta model based on a generic type; and

FIG. 7 is a block diagram of an example network device to transform a data object in a meta model based on a generic type.

### DETAILED DESCRIPTION

The system described herein addresses the need for a flexible and generic way to process incoming data to an IoT system. This approach involves incremental data extraction without mandating the monitored object to send data in a predefined format. Also, this approach moves data transformation and structuring into the backend. Therefore, this system facilitates quick integration of new objects and allows for data extraction and analysis at a later point in time. Dynamic data extraction also allows for incremental development of new processes for fault prediction, monitoring services and reporting. The described system is capable of handling big data and can be scaled up with additional processing power. Additionally, this system allows users to specify and process data dynamically, such that new processing functionalities can be added whenever new data types and structures arise without changing system codes and redeploying the systems. Type definitions can be modified and incrementally evolved over time. Therefore, this approach provides flexible adaptation to incoming data stream changes and dynamic onboarding of new types of monitored objects.

According to embodiments of the present disclosure, the handling of incoming data in an example system is based on two generic definitions: Thing and Thingformation. These two generic definitions abstract the specifics of any incoming data into a generic meta model. Specifically, a Thing generally represents an instance of a real world object that can be either virtual (e.g., a software application) or physical (e.g., a device). On the other hand, a Thingformation generally represents current status information about at least one real world objects. A Thingformation is immutable and can update attributes of its associated Thing(s). Each Thing holds the known current status of the corresponding real world object and maintains a history of changes to that real world object. In addition, handlers are used in the meta model to process data in different types of representations and transform associated data objects. During an onboarding process, a user or administrator defines multiple Thing and Thingformation types, and specifies how their data will be handled. The user or administrator also defines multiple handlers, whereas each handler is associated with at least one configuration. A handler generally defines how incoming data will be handled for specific Thing and Thingformation types.

Meta Model

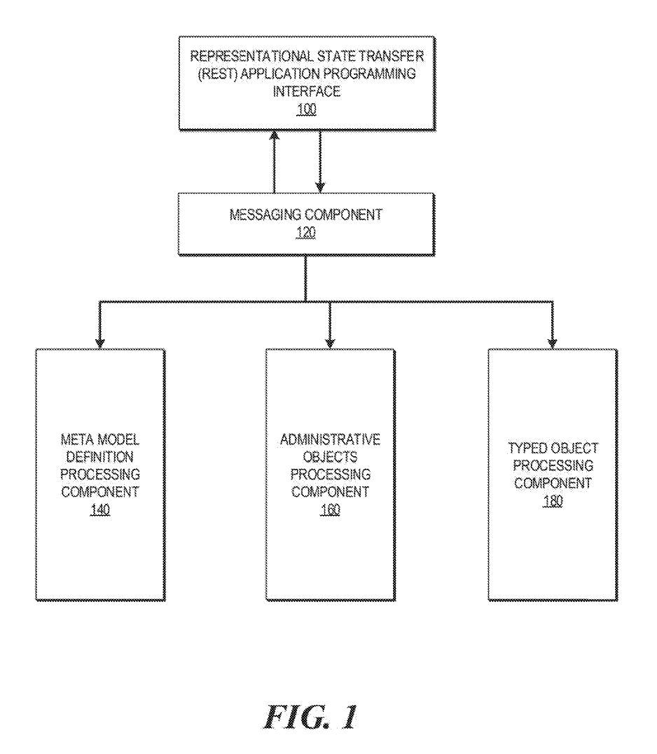

FIG. 1 is a block diagram of an example environment for an IoT meta model. FIG. 1 includes a representational state transfer (REST) application programming interface (API) 100, a messaging component 120, a meta model definition processing component 140, an administrative objects processing component 160, and a typed object processing component 180.

As used throughout this disclosure, “ThingType” refers to a type of “thing,” which represents to an instance of a real world object that can be either virtual (e.g., a software application) or physical (e.g., a device). “ThingType” generally describes a class model for defining IoT classes and attributes. “ThingformationType” refers to a type of “thingformation,” which represents to current status information about at least one real world object. “ThingformationType” generally describes a class model for defining IoT messaging classes and attributes. “RelationshipType” generally describes a class model for defining IoT inter-Thing or inter-Thingformation relationships. “Thing” generally describes an instance model for IoT object instances. “Thingformation” generally describes an instance model for IoT messaging instances. “Relationship” generally describes an instance model for IoT relationship instances. “Handler” generally describes how incoming data will be handled for specific ThingTypes and ThingformationTypes.

To process Thing and Thingformations, the example system utilizes a scalable and reliable framework, allowing massive on-demand parallel processing of data based on the current incoming data stream. For example, Apache Storm is an example framework that provides a compelling feature set combined in a mature and widely used framework. The functionalities of the example system are exposed to users as a RESTful web service via REST API 100.

In addition to the processing, the example system also includes a scalable and distributed communication and messaging framework (e.g., Apache Kafka). Messaging component 120 has a distributed and persistent architecture, and can be scaled to nearly unlimited number of message consumers without impacting the performance of brokers or message producers.

Moreover, the example system includes multiple processing components that perform specific tasks, such as, meta model definition processing component 140, administrative objects processing component 160, and typed object processing component 180. Each of such processing components can retrieve corresponding configuration information based on the type of the data to be handled, and uses a plurality of handlers and configurations to transform and process the incoming data that is unrestricted to any particular format. Each processing component is configured to load and execute a specific handler type.

Meta model definition processing component 140 generally defines data objects and data object types. Administrative objects processing component 160 generally defines objects needed for application management and operation, e.g. security-related objects. Typed object processing component 180 generally processes a wide variety of typed objects. All typed objects can be classified into three generic categories, including but not limited to, a Thing type, a Thingformation type, and other object types. Typed object processing component 180 determines a generic type associated with each input data object or request, and accordingly triggers a corresponding flow, which includes a series of handlers, based on the generic type for processing the typed input data object.

During operations, all incoming data is sent to the system via REST API 100. Messaging component 120 receives the message and processes it. The data is routed within the example system to different processing streams depending on the actual request. For example, retrieval requests are handled in a get stream. All storage requests related to a Thing and/or a Thingformation are handled in their respective processing streams. These example processing streams could be replaced by additional components to further decouple and distribute data processing by splitting it up into multiple topologies. The ability to expand such processing streams accounts for better scalability and performance.

Also, the example system allows for modifying the flows without changing the meta model. For example, handler executors for new handler types could be added to a particular flow without changing the meta model. Likewise, flows could be adjusted or enhanced even outside the example system while still defined in the unchanged meta model.

A. Model Definition Processing Component

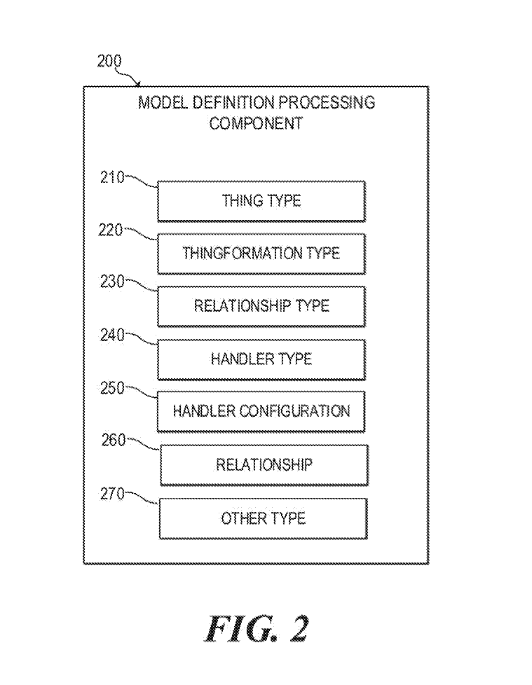

FIG. 2 is a block diagram of an example model definition processing component 200 in the IoT meta model. Model definition processing component 200 includes at least a thing type 210, a thingformation type 220, a relationship type 230, a handler type 240, a handler configuration 250, a relationship 260, and other type 270.

Specifically, thing type 210 (also referred to as “ThingType”) describes a class model for defining IoT classes and attributes associated with a real world virtual and/or physical object, e.g., a blade, a blade center, etc. Thingformation type 220 (also referred to as “ThingformationType”) describes a class model for defining IoT messaging classes and attributes associated with at least one things, e.g., an alert message, an idle message, etc. Relationship type 230 (also referred to as “RelationshipType”) describes a class model for defining IoT inter-Thing or inter-Thingformation relationships. In other words, relationship type 230 defines a relationship between two objects by specifying the types of the object and the relationship. For example, the “contains” relationship type specifies that a “contains” relationship is between a first Thing and a second Thing.

Note that, unlike things and thingformations, relationships are both typed and part of the meta model. In some examples, hierarchies in the meta model are defined by a “parent” relationship. In other examples, there can also be a “contains” relationship that is between Thing types or Thingformation types defined in the meta model (e.g. a blade type contains a blade center type).

Handler type 240 generally defines the type and parameters of a handler. Examples of handler type 240 include but are not limited to a data retrieval handler type, a flattening handler type, an attribute handler type, a data store handler type, an identity handler type, a script handler type, etc.

Handler configuration 250 generally configures a handler by defining its parameters. In one example, handler configuration 250 specifies that, for getting the value for the attribute “serial number,” the “full match attribute handler” should be used with a matching parameter value of “xml/device/sr.”

Relationship 260 generally defines how two objects, e.g. two Things, or a Thing and a Thingformation, are related. One example relationship can be a “blade chassis A” “contains” a “blade B.” Here, “blade chassis” is a first Thing type; and, a “blade” is a second Thing type. The “blade chassis A” is a first Thing of the type “blade chassis.” Likewise, the “blade B” is a second Thing of the type “blade.” The relationship type is a “contains” relationship type between “blade chassis” and “blade.” The particular instance of relationship here involves the “contains” relationship between “blade chassis A” and the “blade B.” As shown in the example above, a “Thing” generally describes an instance model for IoT object instances. A “Thingformation” generally describes an instance model for IoT messaging instances. A “Relationship” generally describes an instance model for IoT relationship instances.

It is important to note that additional generic types can be defined in other type 270 dynamically during operations. Likewise, a new sub-type can be defined dynamically as well, e.g., a new thing type, a new thingformation type, a new relationship type, a new handler type, etc.

B. Administrative Object Processing Component

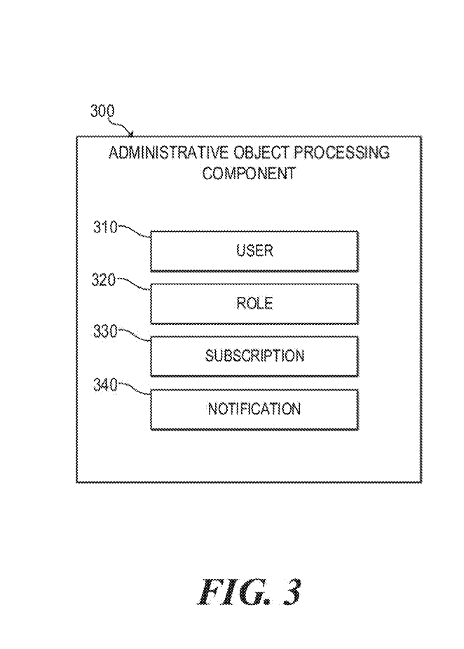

FIG. 3 is a block diagram of an example administrative object processing component 300 in the IoT meta model. Administrative object processing component 300 includes at least a user 310, a role 320, a subscription 330, and a notification 340. Administrative objects generally refer to objects needed for application management and operation, such as, security. User 310 represents a user of the platform. Role 320 refers to a set of permissions. Subscription 330 allows a user 310 to subscribe to changes in the system and automatically receive a notification 340 sent to a uniform resource locator (URL) specified in the subscription. Notification 340 generally includes information about a change.

C. Typed Object Processing Component

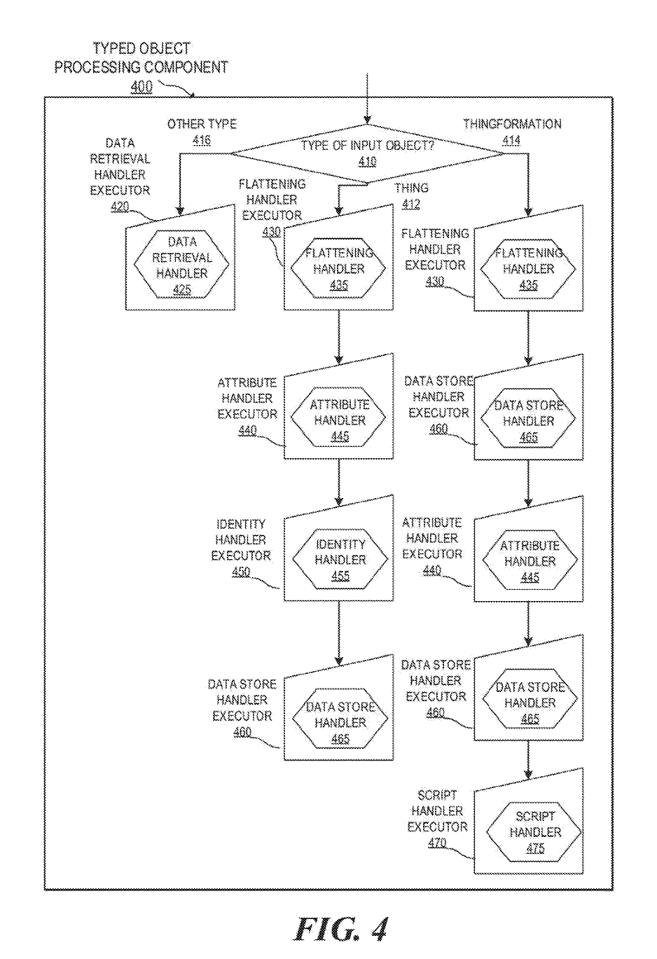

FIG. 4 is a block diagram of an example typed object processing component 400 in the IoT meta model. Typed object processing component 400 includes a determining block that receives an input data object and determines the type of the input data object 410. The input data object can be classified into three generic types, namely, Thing 412, Thingformation 414, and other type 416. Each type is associated with a pre-defined flow in the meta model. The flow is represented by at least one handler executed by a corresponding handler executor. Each handler executor executes a particular type of handler.

The handler types in the meta model may include, but are not limited to, a data retrieval handler type, a flattening handler type, an attribute handler type, an identity handler type, a data store handler type, a script handler type, etc. Specifically, the data retrieval handler type 425 defines a data retrieval handler used for retrieving data, e.g., from a database. Data retrieval handler has a query parameter and returns data.

Flattening handler type 435 defines a flattening handler that transforms data from a complex structure, e.g. an Extensible Markup Language (XML) representation, into a flat list of key/value pairs. Example flattening handlers includes an XML flattening handler and a JavaScript Object Notation (JSON) flattening handler. The parameter of a flattening handler is structured data.

Attribute handler type 445 defines an attribute handler that extracts an attribute value from a list of key/value pairs by matching the key and returning the value. For example, a “full match attribute handler” returns the value when the key exactly matches the match parameter. As another example, a “regex attribute handler” returns the value when the key matches the regex of the match parameter. The parameters to the attribute handler are a list of key/value pairs and a match parameter.

Identity handler type 455 defines an identity handler that determines if an instance of a thing of a certain type is already in the system, or if the instance of a thing is a new instance. In some implementations, an identity handler can be created for each thing type to allow type-specific handling. For example, a “Proliant” thing can be uniquely defined by a product number and serial number combination. On the other hand, a “router” thing type might not have these attributes. Instead, a “router” identity handler might need to do matching on Media Access Control (MAC) addresses. The parameter of an identity handler is an instance of a thing.

Data store handler type 465 defines a data store handler that persists data to a database. A data store handler can be created for each of the thing types or thingformation types, such that the data store handler knows exactly how a particular instance of thing or thingformation should be stored. The parameter to the data store handler is the data to persist.

Script handler type 475 defines a script handler that processes a script, e.g. java script. A script handler can be created for each type of scripts that should be supported. The parameters to the script handler are the actual script and data.

Specifically, when the input data object is determined to be other type 416, the GET stream uses data retrieval handler executor 420, which load a data retrieval handler 425 registered for the processed data type. The data retrieval handler 425 performs the reading of the actual data from its storage location. The result is then wrapped in a message and published to the Out topic. The REST API receives the data from the Out topic and sends a response back to the client.

Processing of new or updated Things 412 is more complex as the example system allows processing of well-formatted data, as well as raw data transmitted in its native format. First, the processing stream of the example system uses a flattening handler executor 430 to execute a flattening handler 435. Flattening handler 435 transforms incoming data object (e.g., a Thing 412) from a complex structure, e.g. an Extensible Markup Language (XML) representation or a JavaScript Object Notation (JSON) representation, into a flat list of key/value pairs.

The unique identity of Things is established by identity attributes as defined in the corresponding Thing type. For example, if a type defines “product number” and “serial number” as identity attributes, then those attribute values in the incoming Thing related data ensure that the same unique Thing 412 instance is modified.

Next, the incoming data for the Thing stream is split to allow parallel processing of the identity attributes by executing a registered and loaded attribute handler 445 using attribute handler executor 440. Then, the processed data is joined and an identity handler 455 executed by identity handler executor 450 uniquely identifies the data based on the processed attribute values. Data that cannot be identified is rejected and an error is returned to the Out topic.

Once a Thing 412 is identified, its additional attributes are processed in a similar way to the identity attributes and the final Thing information is persisted by executing a data store handler 465 using data store handler executor 460. The result of the operation is pushed to the Out topic and returned to the REST API.

Thingformations usually contain larger data collections for Things in a native, raw format. Hence, the topology of the example system allows asynchronous processing of this data using the Thingformation stream. This processing may require an unknown amount of time. Therefore, after storing the most basic information about the submission, a metadata record is returned to the Out topic, allowing the REST API to acknowledge the data and send a response back to the client.

First, the Thingformation processing stream of the example system uses a flattening handler executor 430 to execute a flattening handler 435. Flattening handler 435 transforms incoming data object (e.g., a Thingformation 414) from a complex structure, e.g. an Extensible Markup Language (XML) representation or a JavaScript Object Notation (JSON) representation, into a flat list of key/value pairs.

Decoupled by another Topic, the example system then processes the flat Thingformation data asynchronously using attribute handlers 445 executed by attribute handler executor 440. Data store handler 465 executed by data store handler executor 460 persists the fully processed information. In addition, a script handler 475 may be executed by a script handler executor 470 to processes a script to transform the data object (e.g., Thingformation 414).

Thing and Thingformation attribute definitions can be easily adapted to changing incoming data streams by modifying their respective type definitions. Together with the pluggable handlers, this example system can quickly integrate with new or changed monitored objects.

Processes to Transform a Data Object in a Meta Model Based on a Generic Type

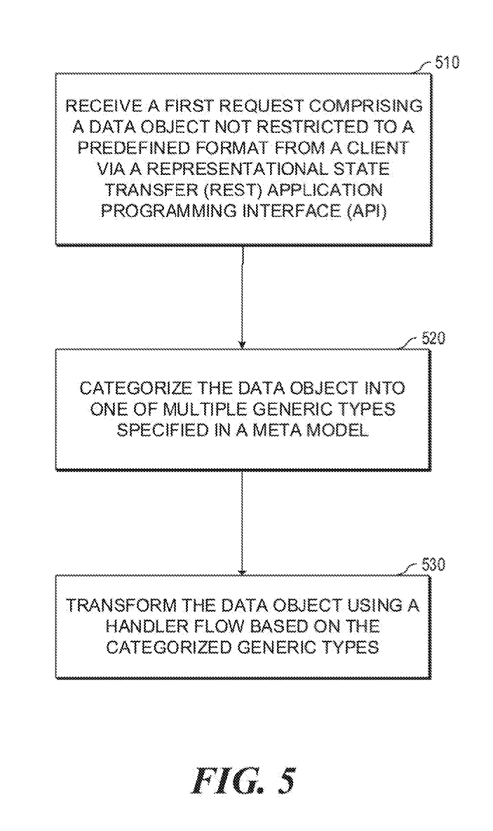

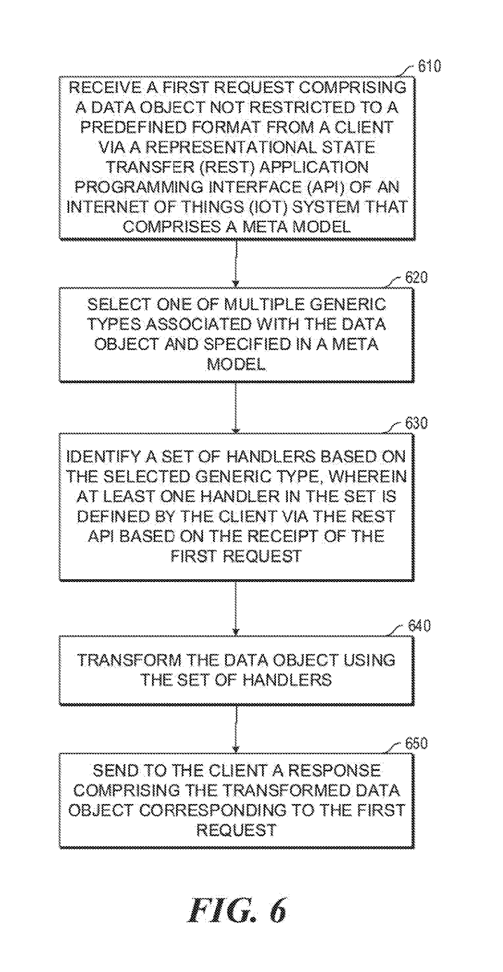

In discussing FIGS. 5-6, references may be made to the components in FIGS. 1-4 to provide contextual examples. In one implementation, a REST controller using meta model described in FIG. 1 executes operations 510-530 to transform a data object in a meta model based on a generic type. In one implementation, the REST controller using meta model described in FIG. 1 executes operations 610-650 to transform a data object in a meta model based on a generic type.

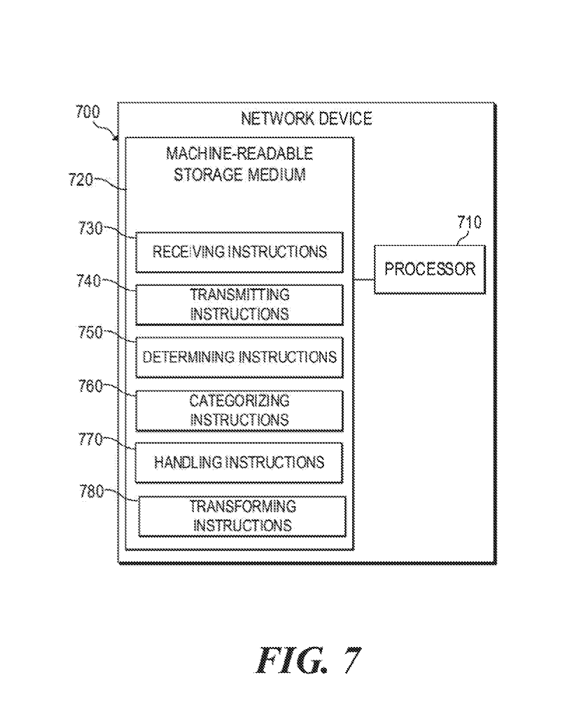

Further, although FIGS. 5-6 are described as implemented by a controller, it may be executed on other suitable devices or components. For example, FIGS. 5-6 may be implemented in the form of executable instructions on a machine-readable storage medium 720 as in FIG. 7.

FIG. 5 is a flowchart of an example process to transform a data object in a meta model based on a generic type. First, a computing device (e.g., a REST controller) receives a first request comprising a data object unrestricted to a predefined format from a client via a representational state transfer (REST) application programming interface (API) (operation 510). Next the computing device categorizes the data object into one of multiple generic types specified in a meta model (operation 520). Then, the computing device transforms the data object using a handler flow based on the categorized generic types (operation 530).

FIG. 6 is a flowchart of another example process to transform a data object in a meta model based on a generic type. In this example, a computing device (e.g., a REST controller) receives a first request comprising a data object unrestricted to a predefined format from a client via a representational state transfer (REST) application programming interface (API) of an Internet of Things (IoT) system that comprises a meta model (operation 610). Then, the computing device selects one of multiple generic types associated with the data object and specified in the meta model (operation 620). Here, the multiple generic types includes a thing, an information, a relationship, and a handler. Next, the computing device identifies a set of handlers based on the selected generic type, wherein at least one handler in the set is defined by the client via the REST API based on the receipt of the first request (operation 630). Subsequently, the computing device transforms the data object using the set of handlers (operation 640), and sends to the client a response comprising the transformed data object corresponding to the first request (operation 650).

Here, the multiple generic types includes a thing, an information, a relationship, and a handler. The thing includes a representation of a physical object instance. The information includes statuses of at least one thing and is immutable. Also, the information is used to update an attribute of the at least one thing. The relationship describes how multiple data objects of same or different generic types in the meta model relate to each other.

In some implementations, the data object corresponds to a new sub-type of the one of the multiple generic types. Moreover, the new sub-type is excluded from the meta model. The computing device can further receive a definition of the new sub-type, and then create the new sub-type of the one of the plurality of generic types in the meta model. Then, the computing device transforms the data object using the flow corresponding to the one of the plurality of generic types without modifications to the set of handlers.

In some examples, the computing device receives a second request that includes a modification to a sub-type of the one of multiple generic types. Here, the data object corresponds to the sub-type being modified according to the second request. Then, the computing device modifies the sub-type of the one of the multiple generic types in the meta model. Also, the computing device transforms the data object of the modified sub-type using the flow corresponding to the one of the plurality of generic types without modifications to the set of handlers.

In some implementations, the computing device can receive a definition of a new handler sub-type. The computing device can then create the new handler sub-type in the meta model. Next, the computing device can include a new handler of the new handler sub-type in the flow without changing the flow by executing the new handler via one of the set of handlers in the flow. Then, the computing device transforms the data object using the flow that includes the new handler. Note that, because the new handler is executed by an existing handler in the flow, there is no need to change the source code, rebuild the system, or redeploy the system during this process. The new handler can be added at the runtime without interrupting any services offered by the REST API.

In some implementations, the computing device can receive a second request comprising a modification to a handler sub-type. At least one handler of the set of handlers in the flow corresponds to the handler sub-type that is being modified according to the second request. Next, the computing device modifies the handler sub-type in the meta model based on the second request. Then, the computing device transforms the data object using the flow that includes the at least one handler corresponding to the modified handler sub-type. Therefore, an existing handler in a flow can be modified at the runtime without interrupting any services offered by the REST API. There is no need to change the source code, rebuild the system, or redeploy the system during this process.

In some implementations, the multiple generic types further includes a customized generic type. The customized generic type includes, for example, a case representing a customer support case in the meta model or a contract representing a business agreement in the meta model.

Network Device to Transform a Data Object in a Meta Model Based on a Generic Type

FIG. 7 is a block diagram of an example network device with at least one processor 710 to execute instructions 730-780 within a machine-readable storage medium 720 to transform a data object in a meta model based on a generic type. Although the network device 700 includes at least one processor 710 and machine-readable storage medium 720, it may also include other components that would be suitable to one skilled in the art. For example, network device 700 may include an additional processing component and/or storage. In another implementation, the computing device (e.g., a REST controller as described in FIG. 1) executes instructions 730-780. Network device 700 is an electronic device with the at least one processor 710 capable of executing instructions 730-780, and as such implementations of network device 700 include a mobile device, server, data center, networking device, client device, computer, or other type of electronic device capable of executing instructions 730-780. The instructions 730-780 may be implemented as methods, functions, operations, and other processes implemented as machine-readable instructions stored on the storage medium 720, which may be non-transitory, such as hardware storage devices (e.g., random access memory (RAM), read only memory (ROM), erasable programmable ROM, electrically erasable ROM, hard drives, and flash memory).

The at least one processor 710 may fetch, decode, and execute instructions 730-780 to transform a data object in a meta model based on a generic type. Specifically, the at least one processor 710 executes instructions 730-780 to: receive a first request comprising a data object unrestricted to a predefined format from a client via a representational state transfer (REST) application programming interface (API); receive a definition of a new sub-type of multiple generic types; receive a definition of a new handler sub-type; receive a second request comprising a modification to a sub-type of one of the multiple generic types; receive a second request comprising a modification to a handler sub-type; categorize a received data object into one of multiple generic types specified in a meta model; select one of multiple generic types associated with the data object and specified in the meta model, the multiple generic types comprising a thing, an information, a relationship, and a handler; identify a set of handlers based on the selected generic type, wherein at least one handler in the set is defined by the client via the REST API after receiving the first request; etc.

Moreover, the at least one processor 710 further executes instructions 730-780 to: create a new sub-type of the one of multiple generic types in the meta model; create a new handler sub-type in the meta model; modify a sub-type of the one of multiple generic types in the meta model; modify a handler sub-type in the meta model based on a second request; include a new handler of a new handler sub-type in the flow without changing the flow by executing the new handler via one of the set of handlers in the flow; transform, based on the one of multiple generic types, the data object using a handler flow; transform the data object using a flow that includes a new handler; transform the data object using a flow corresponding to one of multiple generic types without modification to the set of handlers; transform the data object of a modified sub-type using the flow corresponding to one of multiple generic types without modification to the set of handlers; transform the data object using the flow that includes the at least one handler corresponding to the modified handler sub-type; transform the data object using the set of handlers; send to the client a response comprising the transformed data object corresponding to the first request; etc.

The machine-readable storage medium 720 includes instructions 730-780 for the processor 710 to fetch, decode, and execute. In another example, the machine-readable storage medium 720 may be an electronic, magnetic, optical, memory, storage, flash-drive, or other physical device that contains or stores executable instructions. Thus, the machine-readable storage medium 1020 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 720 may include an application and/or firmware which can be utilized independently and/or in conjunction with the at least one processor 710 to fetch, decode, and/or execute instructions of the machine-readable storage medium 720. The application and/or firmware may be stored on the machine-readable storage medium 720 and/or stored on another location of the network device 700.

We claim:

1. A method comprising:
receiving, by a computing device, a first request comprising a data object unrestricted to a predefined format from a client via a representational state transfer (REST) application programming interface (API);
categorizing, by the computing device, the data object into one of multiple generic types specified in a meta model, the multiple generic types comprising a thing, an information, a relationship, and a handler;
based on the categorized generic type, transforming the data object using a handler flow, wherein a handler in the handler flow is defined by the client via the REST API based on the receipt of the first request.

2. The method of claim 1, wherein the thing comprises a representation of a physical object instance.

3. The method of claim 1, wherein the information comprises statuses of at least one thing and is immutable.

4. The method of claim 3, wherein the information is used to update an attribute of the at least one thing.

5. The method of claim 1, wherein the relationship describes how multiple data objects of same or different generic types in the meta model relate to each other.

6. The method of claim 1, wherein the data object corresponds to a new sub-type of the one of the multiple generic types, and wherein the new sub-type is excluded from the meta model.

7. The method of claim 6, further comprising:
receiving a definition of the new sub-type;
creating the new sub-type of the one of the plurality of generic types in the meta model; and
transforming the data object using the flow corresponding to the one of the plurality of generic types without modification to the set of handlers.

8. The method of claim 1, further comprising:
receiving a second request comprising a modification to a sub-type of the one of the multiple generic types, wherein the data object corresponds to the sub-type;
modifying the sub-type of the one of the multiple generic types in the meta model; and
transforming the data object of the modified sub-type using the flow corresponding to the one of the multiple generic types without modification to the set of handlers.

9. The method of claim 1, further comprising:
receiving a definition of a new handler sub-type;
creating the new handler sub-type in the meta model;
including a new handler of the new handler sub-type in the flow without changing the flow by executing the new handler via one of the set of handlers in the flow; and
transforming the data object using the flow that includes the new handler.

10. The method of claim 1, further comprising:
receiving a second request comprising a modification to a handler sub-type, wherein at least one handler of the set of handlers in the flow corresponds to the handler sub-type;
modifying the handler sub-type in the meta model based on the second request; and
transforming the data object using the flow that includes the at least one handler corresponding to the modified handler sub-type.

11. A system comprising at least a memory and a processor coupled to the memory, the processor executing instructions stored in the memory to:
receive a first request comprising a data object unrestricted to a predefined format from a client via a representational state transfer (REST) application programming interface (API) of an Internet of Things (IoT) system that comprises a meta model;
select one of multiple generic types associated with the data object and specified in the meta model, the multiple generic types comprising a thing, an information, a relationship, and a handler;
identify a set of handlers based on the selected generic type, wherein at least one handler in the set is defined by the client via the REST API after receiving the first request;
transform the data object using the set of handlers; and
send to the client a response comprising the transformed data object corresponding to the first request.

12. The system of claim 11, wherein the thing comprises a representation of a physical object instance, wherein the information comprises statuses of at least one thing.

13. The system of claim 12, wherein the information is immutable and used to update an attribute of the at least one thing.

14. The system of claim 11, wherein the relationship describes how multiple data objects in the meta model relate to each other.

15. The system of claim 11, wherein the data object corresponds to a new sub-type of the one of the multiple generic types, wherein the new sub-type is excluded from the meta model, and wherein the processor further executing instructions to:
receive a definition of the new sub-type;
create the new sub-type of the one of the plurality of generic types in the meta model; and
transform the data object using the flow corresponding to the one of the plurality of generic types without modification to the set of handlers.

16. The system of claim 11, wherein the processor executing instructions stored in the memory further to:
receive a second request comprising a modification to a sub-type of the one of multiple generic types, wherein the data object corresponds to the sub-type;
modify the sub-type of the one of the multiple generic types in the meta model; and
transform the data object of the modified sub-type using the flow corresponding to the one of the multiple generic types without modification to the set of handlers.

17. The system of claim 11, wherein the multiple generic types further comprise a customized generic type.

18. The system of claim 17, wherein the customized generic type comprises a case representing a customer support case in the meta model and a contract representing a business agreement in the meta model.

19. A non-transitory machine-readable storage medium encoded with instructions executable by at least one processor of a network device, the machine-readable storage medium comprising instructions to:
receive from a client a data object to be transformed in a meta model comprising multiple generic types;
categorize the data object into one of multiple generic types that comprise a thing, an information, a relationship, and a handler;
transform the data object using a flow comprising a set of handlers corresponding to the one of multiple generic types, wherein at least one handler in the set is defined by the client after receiving the first request.

20. The non-transitory machine-readable storage medium of claim 19, further comprising instructions to:
receive a second request comprising one of a modification to and an addition of a handler sub-type, wherein at least one handler of the set of handlers in the flow corresponds to the handler sub-type;
modify the handler sub-type in the meta model based on the second request; and
transform the data object using the set of handlers including the at least one handler corresponding to one of a modified handler sub-type and an added handler sub-type.
